(19) United States
(12) Patent Application Publication
(10) Pub. No.: US 2017/0258689 A1
(43) Pub. Date: Sep. 14, 2017

(54) Teething Glove

(71) Applicant: Regina A. Drysdale, Coeur D Alene, ID (US)

(72) Inventor: Regina A. Drysdale, Coeur D Alene, ID (US)

(21) Appl. No.: 14/618,823

(22) Filed: Feb. 10, 2015

(51) Int. Cl. A61J 17/02; A41D 19/00

(52) U.S. Cl. CPC A61J 17/02; A41D 19/002; A61J 2200/44

(57) ABSTRACT

A teething glove is provided for cold relief associated with the discomfort that generally accompanies infant teething. The teething glove may include a temporary and/or permanent cold pack. The cold pack may provide a child relief while chewing and/or sucking on the portion of the teething glove containing the cold pack.

### TECHNICAL FIELD

Aspects of the disclosure relate generally to infant/toddler products. More particularly, the present disclosure relates to a teething glove including a cold pocket to provide cold relief associated with discomfort that generally accompanies infant teething.

### BACKGROUND

Teething is the process by which an child's first teeth appear by emerging through the gum line. Teething generally starts around 6 months of age however, it is normal for teething to start any time between the age of 3 months and 12 months of age. Typically, the lower front teeth come in first, with the upper front teeth following approximately 1 to 2 months later. Teething may cause soreness and swelling of a child's gum and/or gum line as the teeth begin to show. Generally, teething may cause a child to be excessively fussy. Many parents offer their children traditional plastic teethers to aid in the discomfort that accompanies teething. Often, parents will freeze the traditional plastic teether to further aid in the discomfort caused by teething. However, the American Pediatric Association warns against freezing traditional teethers because of dangers resulting from the potential of freezing a child's gum(s), lip(s), and/or hands. Therefore, there is a need for a teether that provides cold relief to a child's teething discomfort.

### BRIEF DESCRIPTION OF THE DRAWINGS

Reference will now be made to the accompanying drawings, which are not necessarily drawn to scale, and wherein:

FIG. 1 illustrates an example teething glove situated on a user hand, according to one exemplary embodiment.

FIGS. 2A and 2B illustrates an example closing strap for use with the teething glove illustrated in FIG. 1, according to one exemplary embodiment.

FIG. 3 illustrates an example pouch including a cold packet for use with the teething glove illustrated in FIG. 1, according to one exemplary embodiment.

FIG. 4 illustrates another example pouch including a cold packet for use with the teething glove illustrated in FIG. 1, according to one exemplary embodiment.

FIG. 5 illustrates a teething glove that may be utilized by a child, according to an exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Teething Glove Overview

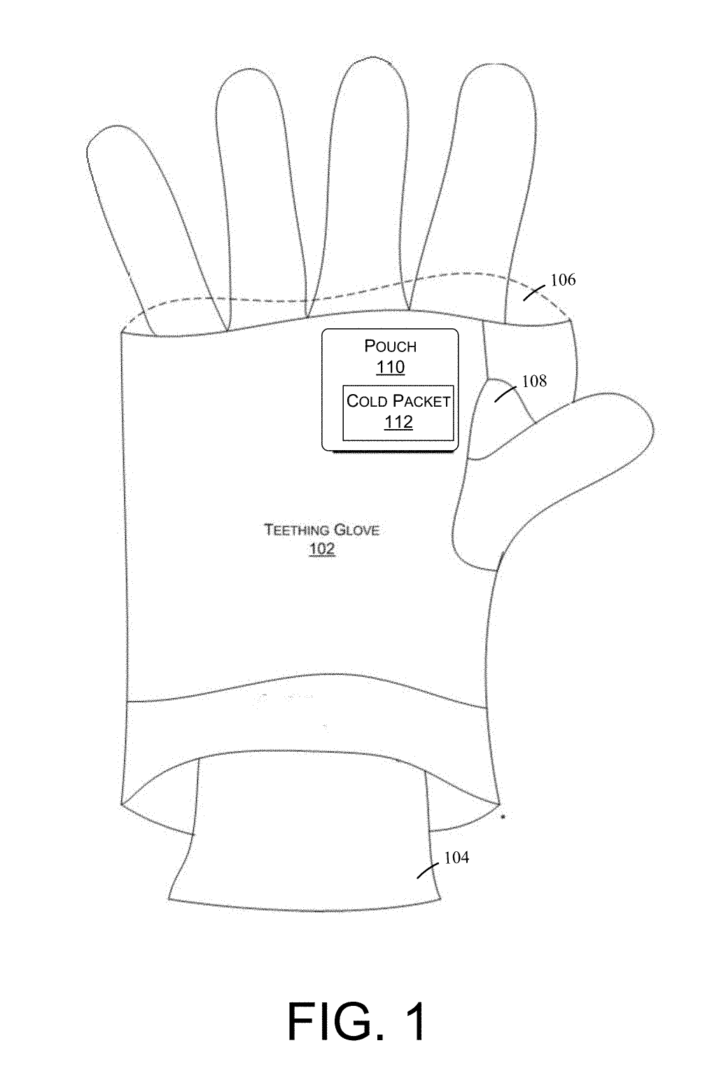

Exemplary embodiments described herein identify components of a teething glove utilized to sooth and relieve discomfort associated with teething. A teething glove 102 is shown in FIG. 1. As shown in FIG. 1, the teething glove 102 is designed to fit on a hand of a user 104. In one exemplary implementation, the user 104 is a child ranging in age between birth and two years of age. However, it is to be appreciated that the teething glove 102 may be utilized by a user of any suitable age. The teething glove 102 may be placed on a right hand of the user 104 or a left hand of the user 104. While FIG. 1 illustrates the teething glove 102 on a single hand, the right hand, a teething glove 102 may also be placed on the left hand for simultaneous use on both the right hand and the left hand of the user 104.

In one example implementation, the teething glove 102 may be constructed of an organic cotton material, such as, for example, a terry cloth material. Generally, terry cloth is a fabric with loops that enable the absorption of large amounts of water. The length of the loops making up the terry cloth help to determine how much fluid may be absorbed by the cloth. Utilizing an absorbing material, such as terry cloth, may provide the user 104 additional comfort as any liquid (e.g., saliva, drool, etc.) exiting a mouth of the user 104 may be captured by the teething glove 102. By way of another example, the teething glove 102 may be constructed using other organic cotton materials. For example, without limitation, an unbleached cotton twill, a cotton fleece, a cotton velour, or the like. While the teething glove is described as being constructed of a cotton material, it is to be appreciated that the teething glove 102 may be constructed using any suitable material. For example, without limitation, the teething glove 102 may be constructed using a hemp material. Hemp is an environmentally friendly product that does not require the use of a lot of fertilizers and/or pesticides. Hemp is a durable and absorbent product that has a natural anti-microbial and anti-mildewing properties. Some examples of hemp materials that may be used to construct the teething glove 102 may include, without limitation, a hemp french terry material, a hemp fleece, or the like.

The teething glove 102 may include an opening 106. The opening 106 may enable the user's fingers to extend through and out of the teething glove 102. For example, the teething glove 102 may include a single opening, such that an index finger, a middle finger, a ring finger and a pinky finger are grouped together in the single opening. Alternatively, the teething glove 102 may include an opening for each finger. For example, the teething glove 102 may include four separate compartments, a first compartment for the index finger, a second compartment for the middle finger, a third compartment for the ring finger, and fourth compartment for the pinky finger. Whether the teething glove 102 includes a single opening or four separate compartments for each finger, the fingerless, open ended design provides free unencumbered movement for the fingers of the user 104. For example, the fingers of the user 104 are free to explore and/or play with toys while the teething glove remains securely fastened to the hand of the user 104. However, while the teething glove 102 illustrates an open ended design, it is to be appreciated the teething glove 102 may alternatively encapsulate the fingers such that the teething glove 102 covers the entirety of the user's hand (e.g., including the fingers).

The teething glove 102 may also include a thumb opening 108. The thumb opening 108 enables the user's thumb to extend through and out of the teething glove 102 in a similar manner described herein with respect to the opening 106. For example, similar to the opening 106, the thumb opening 108 may be an open ended design providing the thumb free unencumbered movement. Alternatively, the thumb opening 108 may encapsulate the entirety of the thumb.

The teething glove 102 may also include a pouch 110. The pouch 110, in one example implementation, may be located in between where the index finger and the middle finger of the user 104 may exit the opening 106 of the teething glove 102. For example, the pouch 110 may be situated on the teething glove such that it is positioned between a knuckle associated with the index finger of the user and a knuckle associated with the middle finger of when the hand of the user is placed in the teething glove 102. By way of another example, the pouch 110 may be placed in the middle of a user's hand. For example, the pouch 110 may be placed on the teething glove 102 such that it is positioned directly over where a knuckle associated with the middle finger of the user 104 would be located when the user's 104 hand is placed in the teething glove. However, it is to be appreciated that the pouch 110 may be situated in any suitable location on the teething glove 102. While the teething glove 102 is illustrated to include a single pouch 110, it is to be appreciated that the teething glove 102 may include multiple pouches located in multiple locations of the teething glove 102.

The pouch 110 may hold a cold packet 112. In one example implementation, the cold packet 112 may contain a fluid that will not transform to a solid state when placed into a household appliance such as, for example, a freezer (set at an average freezer temperature), a refrigerator, or the like. For example, the fluid may consist of, without limitation, a corn syrup, a honey product, a silicon product, or the like. By way of another example, the cold packet 112 may contain a water/sugar mixture. For example, the water/sugar mixture may be a one part water and four part sugar mixture. However, it is to be appreciated that the water/sugar mixture may be any suitable mixture.

The pouch 110 may include a single cold packet 112, or multiple cold packets. For example, a single pouch 110 may include one or more cold packets 112. Alternatively and/or additionally, where the teething glove 102 may include multiple pouches 110, each pouch may include one or more cold packets 112. However, it is to be appreciated, that a pouch may not include any cold packet at all, and may be used as an alternative location for placement of a cold packet 112. For example, a teething glove 102 may include a first pouch situated on the knuckle associated with the index finger of the user 104 as well as a second pouch situated in a middle of the hand of the user 104. The cold packet 112 may be moved between the first pouch and the second pouch as desired by the user 104. Alternatively, for example, the user 104 may prefer the cold packet in the first pouch, and the second pouch may not be utilized at all.

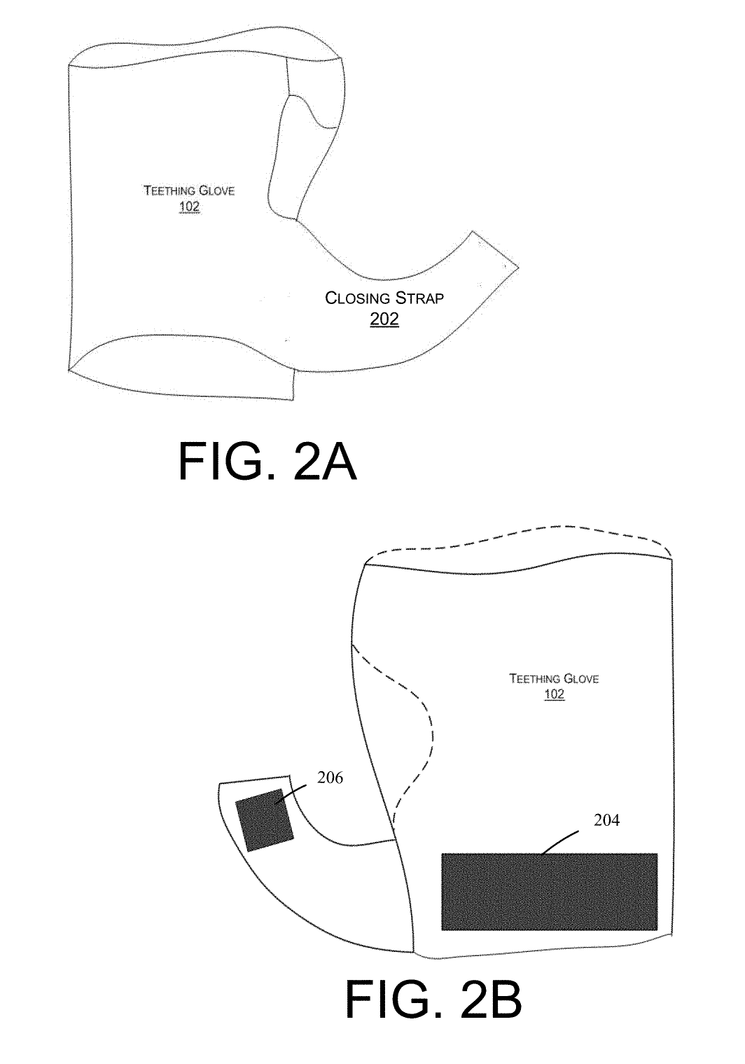

FIG. 2A further illustrates the teething glove 102. In one example implementation, the teething glove 102 may further include a closing strap 202. The closing strap 202 may utilize, in one example, a velcro strip to secure the teething glove 102 to a user 104. In one example, the closing strip 202 secures the teething glove 102 to a user 104 at a user's wrist. For example, as illustrated in FIG. 2B, the closing strap 202 may include velcro strips 204 and 206 that open and close the teething glove 102, securing the teething glove 102 to the user's hand. Alternatively, the teething glove may utilize elastic within the closing strip 202, extending and/or contracting to ensure a proper fit of the teething glove 102 to the user 104. For example, the elastic may be placed within the closing strip of the teething glove 102 providing a single opening for the user 104 to slide their hand into when placing the glove on the hand. The elastic may provide the teething glove 102 a one size fits all for a wide variety of users ranging in both size and/or age. By way of another example, the teething glove 102 may include an elastic opening varying in size, for example, a small opening, a medium opening, or a large opening. A small opening may include an elastic band sized to fit a smaller hand, while a large opening may include a larger elastic band accommodating a larger hand. The closing strap 202 ensures a secure fit to the user's hand, preventing the teething glove 102 from falling off of the user's hand or from the user throwing the teething glove 102 to the ground.

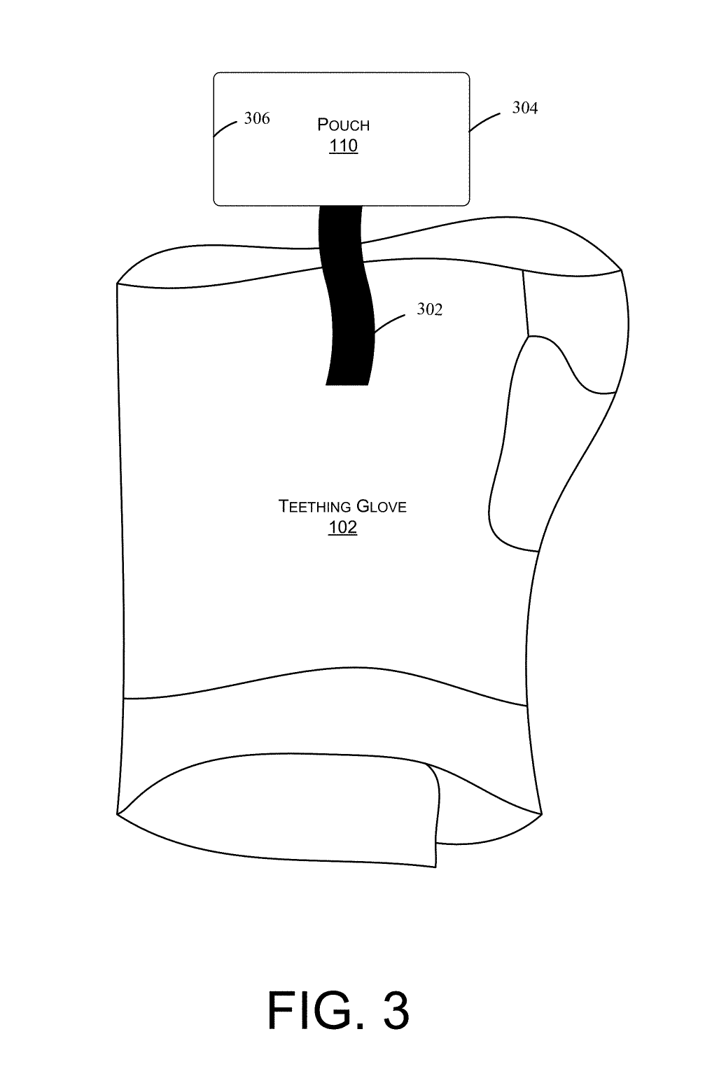

FIG. 3 illustrates a pouch 110 of the teething glove 102. In one example implementation, the pouch 110 may be secured to the teething glove 102 using a tether 302. The tether 302, may be, for example, an elastic tether that is securely attached to the teething glove 102. However, the tether 302 may be, without limitation, constructed using material similar to the teething glove 102, or any suitable material. The tether 302 may be secured to the teething glove permanently, for example, sewn to the teething glove 102. Alternatively, the tether 302 may be removable from the teething glove 102. For example, the tether 302 may be temporarily secured to the teething glove using a velcro attachment.

The pouch 110 may include a velcro attachments at a first end 304 and a second end 306 to secure closure of the pouch 110. The velcro attachments at the first end 304 and the second end 306 may secure the cold packet 112 in the pouch 110. The cold packet 112 may be removed from the pouch 110 of the teething glove 102. When removed, the cold packet 112 may be chilled by placing the cold packet 112 into the appliance (e.g., a freezer, a refrigerator, or the like). Placement of the cold packet 112 in an appliance may accompany an initial chilling process for the cold packet 112, and/or placement of the cold packet 112 in an appliance may be to re-chill the cold packet 112. As described herein, by chilling the cold packet 112, the teething glove 102 may provide the user 104 cold relief during times of discomfort (e.g., during times of discomfort associated with teething). Alternatively, the cold packet 112 may be sewn into the pouch 110 during the manufacturing process and is thus not removable from the teething glove 102. Whether the cold packet 112 is sewn into the pouch 110, or the cold packet 112 is removable from the pouch 110, the teething glove 102, including the cold packet 112, may be placed into the appliance such that the entire teething glove 102 is chilled.

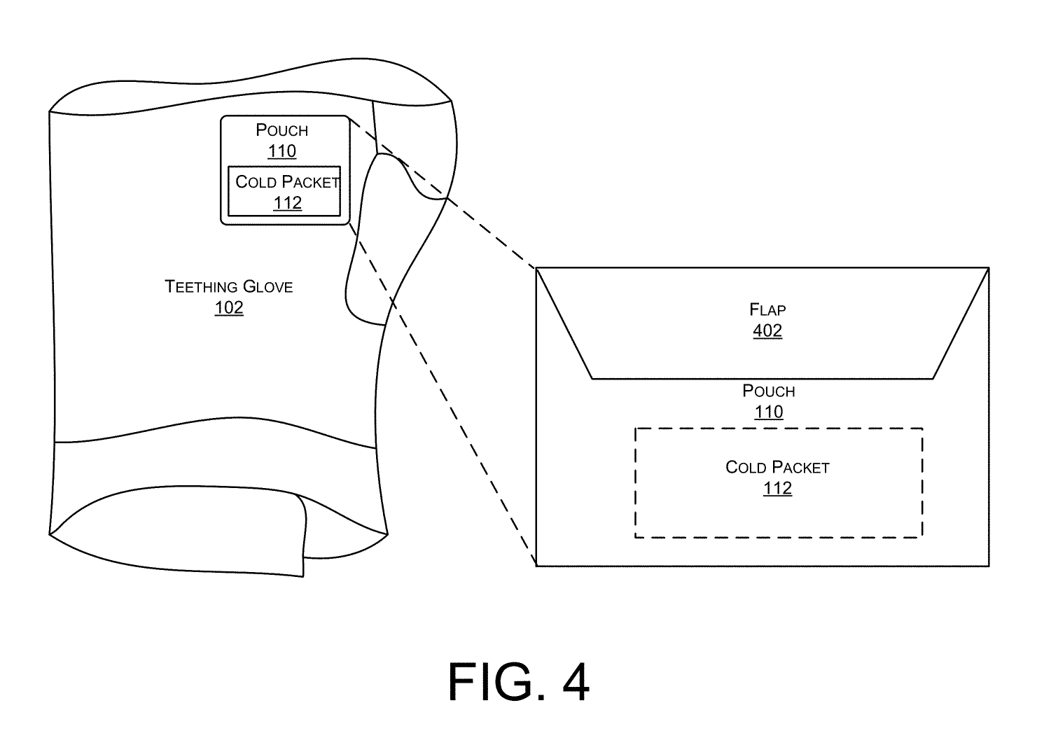

FIG. 4 further illustrates the another pouch 110 of the teething glove 102. In one example implementation, the pouch 110 may include a flap 402. The flap 402 may secure the cold packet 112 in the pouch 110. In one example implementation, the flap 402 may use a velcro strip similar to the closing strap 202 to secure the closure of the pouch 110. Alternatively and/or additionally, the pouch 110 may be securely closed using any other suitable methods. Alternatively, the cold packet 112 may be sewn into the pouch 110 during the manufacturing process and is thus not removable from the teething glove 102. As described with respect to FIG. 3, whether the cold packet 112 is sewn into the pouch 110, or the cold packet 112 is removable from the pouch 110, the teething glove 102, including the cold packet 112, may be placed into the appliance such that the entire teething glove 102 is chilled.

Use Case Scenario

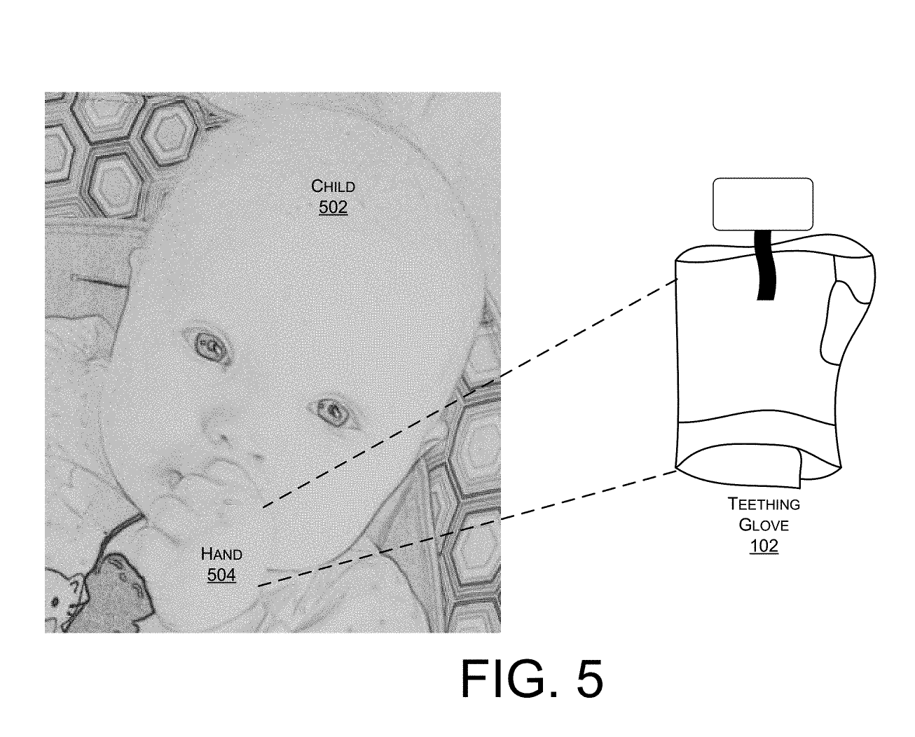

This exemplary use case scenario will be described with reference to the teething glove 102, and is illustrated in FIG. 5. The user 104 may be a child, such as a child 502. The child 502 may be a child undergoing discomfort as the result of teething. A parent may secure the teething glove 102 on the child's hand 504. Securing the teething glove to the child's hand prevents the child from dropping the teething glove and/or throwing the teething glove off of their hand. The child 502 may place the teething glove 102 in or near a child's mouth, exposing the cold pouch 112 to the child's gum line (e.g., an area typically affected during the teething process and subsequently causing the child discomfort). The cold pouch 112 may provide the child soothing relief to the affected area, thus easing the child's discomfort.

While a scenario has been described, it is to be appreciated that various alternative use case scenarios for the teething glove may be recognized for utilizing the teething glove as defined by the claims. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A teething glove comprising:
a first opening permitting one or more fingers of a user to extend through and out of the teething glove;
a second opening permitting a thumb of a user to extend through and out of the teething glove;
a closing strap utilized to fasten the teething glove to a hand of the user; and
a pouch comprising a packet containing at least one cold fluid, the pouch situated on the teething glove in a position accessible by a mouth of the user.

2. The teething glove of claim 1, wherein the pouch is attached to the teething glove using at least one tether, the pouch further comprising at least a first closure at a first end of the pouch and a second closure at a second end of the pouch, wherein the first closure and the second closure secure the packet containing the at least one cold fluid inside the pouch.

3. The teething glove of claim 1, wherein the packet containing the at least one cold fluid is removable from the pouch.

4. The teething glove of claim 1, wherein the packet comprises a least one of a glucose material or a silicon material.

5. The teething glove of claim 1, wherein the another pouch is situated on the teething glove in another position also accessible by the mouth of the user.

6. The teething glove of claim 5, wherein the another pouch comprises another cold packet containing at least one fluid.

7. The teething glove of claim 6, wherein the another cold packet contains the same fluid as the cold packet.

8. The teething glove of claim 1, wherein the pouch is situated on a body of the teething glove, and wherein the pouch comprises a flap closure utilized to secure the packet containing the at least one cold fluid inside the pouch.
